(19) United States
(12) Patent Application Publication
(10) Pub. No.: US 2007/0226653 A1
(43) Pub. Date: Sep. 27, 2007

(54) Systems and methods for dynamically designing a product with digital content

(76) Inventors: Michael R. Moore, Folsom, CA (US); Daniel A. Kaye, Folsom, CA (US); Kenneth A. Turcotte, Folsom, CA (US); Randy J. Jongens, Folsom, CA (US); Michael D. Wang-Helmke, Carmichael, CA (US); Peter A. Tjeerdsma, Fair Oaks, CA (US); Christopher H. Davey, Sacramento, CA (US); Daniel N. Sashko, Roseville, CA (US)

Correspondence Address: CARR & FERRELL LLP, 2200 GENG ROAD, PALO ALTO, CA, 94303, US

(21) Appl. No.: 11/711,550

(22) Filed: Feb. 26, 2007

Related U.S. Application Data
(60) Provisional application No. 60/776,549, filed on Feb. 24, 2006.

(51) Int. Cl. G06F 3/048

(52) U.S. Cl. 715/838

(57) ABSTRACT

A user interface configured to display a visual representation of a product from a plurality of product choices is used to select a background from a plurality of background choices for application to a surface of the product. An item of digital content is added to at least a portion of the surface of the product, and a display of the product with the item of digital content is generated that is substantially similar to a view of a physical form of the product with the item of digital content.

### CROSS-REFERENCE TO RELATED APPLICATIONS

The present application claims the benefit and priority of U.S. Provisional Patent Application Ser. No. 60/776,549 filed on Feb. 24, 2006 and entitled “Automated Creation and Real-Time Photo-Realistic Preview of Physical Product That Uses Printed Digital Imagery (A System, Process and User Interface Product),” which is herein incorporated by reference; the present application incorporates by reference U.S. patent application Ser. No. 11/517,823 filed on Sep. 7, 2006 and entitled “Systems and Methods for Organizing Media Based on Associated Metadata,” which claims the benefit and priority of U.S. Provisional Patent Application Ser. No. 60/715,002 filed on Sep. 7, 2005 and entitled “Dynamic Content Authoring Based on Associated Metadata,” which is herein incorporated by reference; and the present application incorporates by reference U.S. patent application Ser. No. 11/437,207 filed on May 19, 2006 and entitled “Systems and Methods for Web Server Based Media Production,” which claims the benefit and priority of U.S. Provisional Patent Application Ser. No. 60/682,371 filed on May 19, 2005 and entitled “A User Interface and Theme-Based Content Template Design for the Automated Authoring, Production, and Delivery of Multiple Forms of Digital Media,” which is herein incorporated by reference.

### BACKGROUND OF THE INVENTION

1. Field of the Invention

The present invention relates generally to digital content presentation, and more particularly to systems and methods for dynamically designing a product with digital content.

2. Description of Related Art

In digital photography, the cost and complexity of printing and producing satisfying products with multiple items of digital content has been extremely difficult and limited to those individuals with professional skills and equipment. Thus, there is a need for systems and methods for dynamically designing a product with digital content.

### SUMMARY OF THE INVENTION

The present invention provides systems and methods for dynamically designing a product with digital content. A user interface configured to display a visual representation of a product from a plurality of product choices is used to select a background for application to at least a portion of a surface of the product. An item of digital content is added to at least a portion of the surface of the product, and a display of the product with the item of digital content is generated. The display is substantially similar to a view of a physical form of the product with the item of digital content.

### BRIEF DESCRIPTION OF THE DRAWINGS

FIG. 1 illustrates a block diagram of exemplary user interface application for designing a product with digital content;

FIGS. 2A-2B illustrate an exemplary user interface for designing a product with digital content;

FIG. 3 illustrate and exemplary editing screen for designing a product with digital content;

FIG. 4 illustrates an exemplary control point screen for disengaging a product with digital content; and

FIG. 5 illustrates a flow diagram of an exemplary process for dynamically designing a product with digital content.

### DETAILED DESCRIPTION

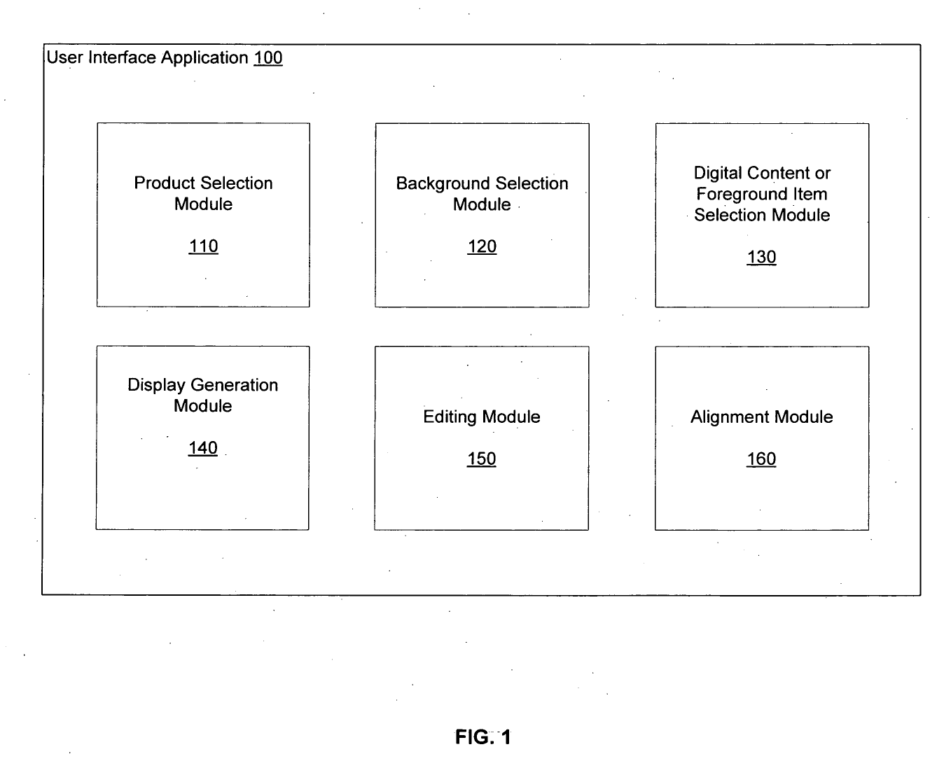

FIG. 1 illustrates a block diagram of exemplary user interface application 100 for designing a product with digital content. According to various exemplary systems and methods, the exemplary user interface application 100 may be installed on a standalone client, such as a kiosk, mobile system, personal computer, cellular phone and/or personal digital assistant (“PDA”). Such installations may also include support for the standalone client making periodic connections to a network, not limited to the Internet, in order to transmit files to a server and/or a production facility. In further systems and methods, files may be transferred via digital transfer media such as a CD-ROM, or even shared with other people via the Internet.

The exemplary user interface application 100 may be implemented on a client using a combination of dynamic HTML and Active-X components for presenting commands, menu options and system status to a user in an aesthetically pleasing and easily understandable format. According to further systems and methods, a client may be configured with the exemplary user interface application 100 in the form of a web browser application for use in connection with such web browsers as Internet Explorer, Netscape Navigator, Firefox, Safari, and/or Mozilla.

The exemplary user interface application 100 shown in FIG. 1 comprises a product selection module 110, a background selection module 120, a digital content or foreground item selection module 130, a display generation module 140, an editing module 150 and an alignment module 160. According to various exemplary systems and methods, products include, however are not limited to, most consumer products including cups, coffee mugs, digital content collages, posters, plates, T-shirts, photo books, and mouse pads. Digital content or foreground items may include audio, video, audiovisual, pictorial, photographic, all image forms, text files, and all variations and combinations thereof.

The product selection module 110 provides the exemplary user interface application 100 with a plurality of product choices from which a user may select a product. The product selection module 110 is further configured to display a visual representation of the product selected by the user.

The background selection module 120, according to one exemplary system and method, provides the exemplary user interface application 100 with a plurality of background choices from which a user may select at least one background for application to at least a portion of the surface of a product. A background may be a collection of graphical elements pertaining to a particular theme, event and/or occasion. For example, a user may select a background representing a particular season or occasion for application to a portion of a surface of a product. According to further exemplary systems and methods, certain background choices may include features for optimally adapting a particular background to accommodate a particular product and/or to accommodate multiple items of digital content or foreground items for a particular product choice. For instance, a circular background having space for two or more items of digital content might be used for a dinner plate, a long horizontal layout having space for several items of digital content might be used for a coffee mug, or a tall narrow layout having numerous carve-outs or markings of various sizes and shapes for numerous items of digital content might be used for a poster.

According to various exemplary systems and methods, the digital content or foreground item selection module 130 provides the exemplary user interface application 100 with the ability for a user to add an item of digital content to at least a portion of a surface of a product. The surface of the product may or may not have a background applied to it. For instance, after a user selects a background for application to the surface of a product, the user may add a digital image to that part of the surface of the product.

The exemplary display generation module 140 generates a preview, view and/or display of a product with an item(s) of digital content that is substantially similar to a corresponding view of a physical form of the same product with the same item(s) of digital content. According to various exemplary systems and methods, a preview, view and/or display of a product with one or more items of digital content textured onto a surface of the product (with or without a background selection) is generated to appear nearly exactly the same way as a physical form of the same product having the same item(s) of digital content would appear if the product was manufactured.

According to one exemplary system and method, the editing module 150 provides the user interface application 100 with the ability for a user to arrange a background and/or one or more items of digital content or foreground items that have been selected for a particular product. Additionally, the editing module 150 may be used to add, delete or modify embellishments such as text, captions, and the like that accompany a selected background and/or one or more items of digital content. At or near the same time a user is using the exemplary editing module 150, the exemplary display generation module 140 is generating a display of the product showing the changes made by the user to a background and/or digital content while using the editing module 150.

The exemplary alignment module 160 provides the user interface application 100 with the ability for a user to align a background and/or item(s) of digital content or foreground item(s) on a particular product. By using a computer mouse or other selection mechanism to click and drag one or more control points that are superimposed over a background and/or item(s) of digital content, a user may facilitate a proper and/or aesthetically satisfying alignment of a background and/or item(s) of digital content to a singular or multi-dimensional shape of a particular product.

Although various modules are shown in connection with the exemplary user interface application 100, fewer or more modules may comprise the exemplary user interface application 100 and still fall within the scope of various embodiments.

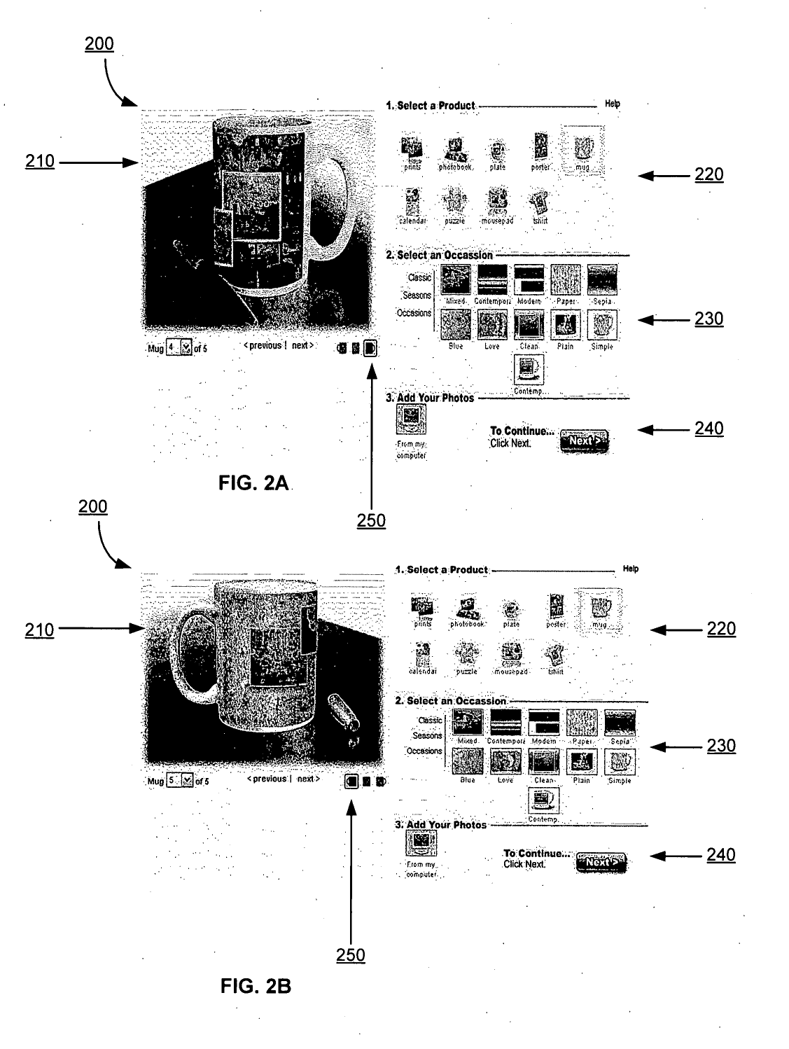

FIGS. 2A-2B show an exemplary user interface 200 for designing a product with digital content. The exemplary user interface 200 comprises a display window 210, product choices 220, background choices 230, digital content or foreground item selection 240 and multiple angle display buttons 250. FIG. 2B shows a display of an alternative angle of the illustrated coffee mug shown in FIG. 2A.

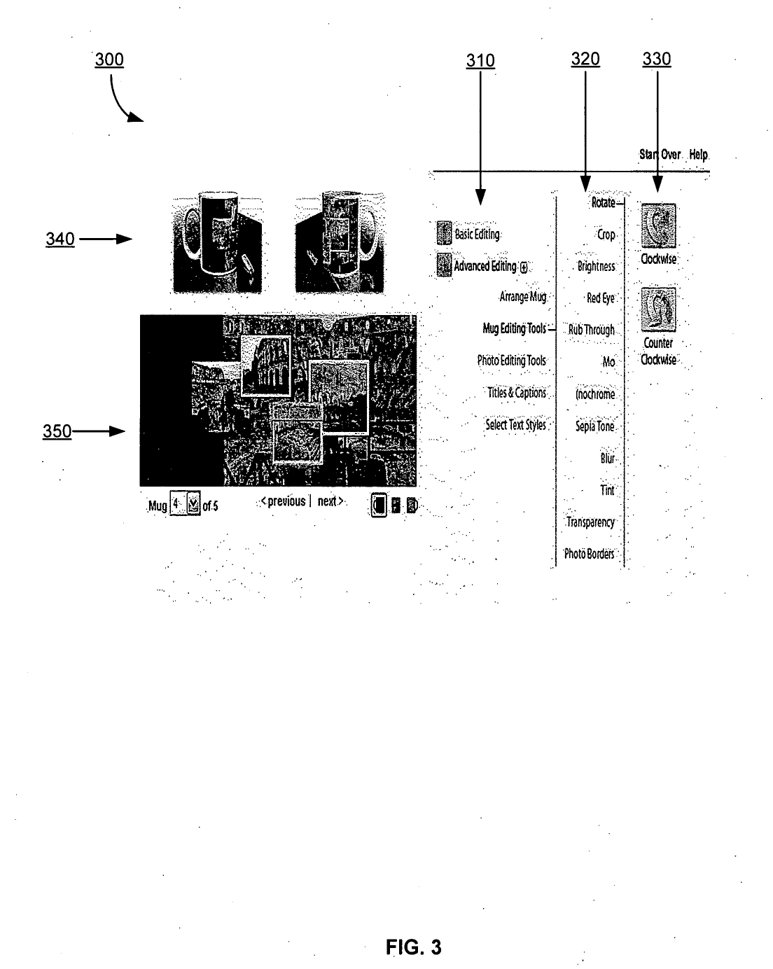

According to various exemplary systems and methods, upon a user selecting a product from the product choices 220, a visual representation of the product is displayed in the display window 210. The user may select a background from the plurality of background choices 230 for application to at least a portion of the surface of the selected product. The user may add or select one or more items of digital content to at least a portion of the surface of the product, by using digital content or foreground item selection 240. A display of the product with the item of digital content is generated in display window 210. The display in display window 210 is substantially similar to a view of a physical form of the same product having the same item of digital content. When multiple displays of the product with digital content are available (e.g., different camera angles), the exemplary user interface 200 may automatically offer a user the multiple angle display buttons 250. When the user activates one of the angle display buttons 250, a second display of an alternative angle of a particular product is generated in the display window 210. FIG. 2B shows a display of an alternative angle of the coffee mug shown in the display window 210 of FIG. 2A, after the user has activated angle display button 250. As described in connection with FIG. 3, according to further exemplary systems and methods, multiple angles of a product may be displayed simultaneously side-by-side.

Additionally, a user utilizing the exemplary user interface 200 may select a second product from the product choices 220 to display the second product in context of background and/or item(s) of digital content selected for a first product. For example, the user may wish to display the background and/or digital content illustrated on the coffee mug in FIGS. 2A-2B on a second product, such as a T-shirt, by selecting the T-shirt icon from product choices 220. Additionally, the user may wish to select a second background from the plurality of background choices 230 to display on a first or second product. For example, the user may wish to display a second background on the coffee mug in FIGS. 2A-2B, such as a blue background, by selecting the blue background icon from background choices 230.

According to further exemplary systems and methods, the exemplary user interface 200, may offer additional selections for customizing a particular product. For example, these selections may include photo size and paper type for a collage of digital content; photo size, paper type and mounting selections for a poster; photo size, plate material and color for a plate; size and material for a T-shirt; binding type, cover material and color for a photo book; and size and material for a mouse pad.

FIG. 3 illustrates an exemplary editing screen 300 for designing a product with digital content. The exemplary editing screen 300 comprises basic and advanced editing selections 310, mug editing tools 320, rotation options 330, multiple product angle display window 340, and edit display window 350.

The exemplary editing screen 300 enables a user to arrange digital content or foreground items that are displayed in edit display window 350, while simultaneously viewing a display of the edits with respect to a particular product in the multiple product angle display window 340. For example, as illustrated in FIG. 3, a user may add one or more items of digital content or foreground items to a collection of digital content that may be displayed in edit display window 350. At the same time, the user may see a display of the edited collection of digital content as applied to a particular product in the multiple product angle display window 340. Further, the exemplary editing screen 300 may allow a user to provide text titles and/or captions to a background selection and/or digital content that may also be displayed in edit display window 350, and to view a display of the edited background and/or digital content as applied to a particular product in the multiple product angle display window 340.

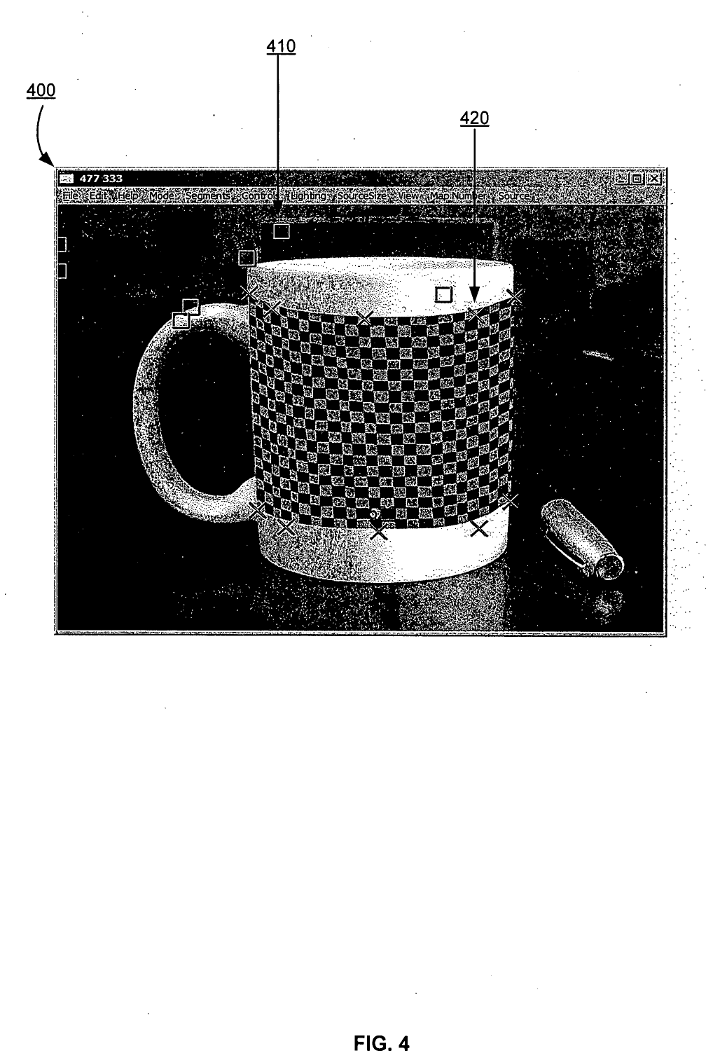

FIG. 4 illustrates an exemplary control point screen 400 for designing a product with digital content. The exemplary control point screen 400 comprises part of the exemplary user interface 200 (FIG. 2). The exemplary control point screen 400 shown in FIG. 4 has a plurality of control points as shown by representative control point 410 and representative control point 420.

According to some exemplary systems and methods, a background selection and/or one or more items of digital content or foreground items may be displayed in the exemplary control point screen 400, so as to create an image of being wrapped around a particular product. For example, in the exemplary control point screen 400, the checkerboard appears wrapped around the displayed coffee mug. By using a computer mouse or other selection mechanism to click and drag one or more control points, such as representative control point 410 and/or representative control point 420, a user may facilitate a proper and/or aesthetically satisfying alignment of a background and/or item(s) of digital content to a singular or multi-dimensional shape of a particular product, such as the coffee mug shown in FIG. 4.

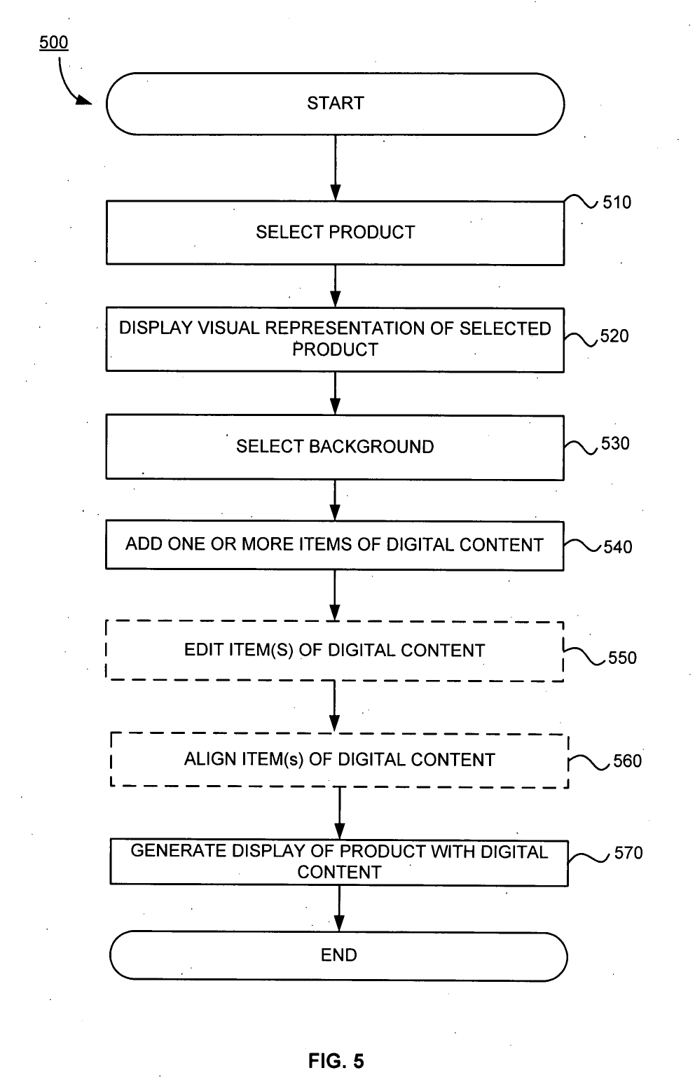

FIG. 5 illustrates a flow diagram of an exemplary process 500 for dynamically designing a product with digital content.

At step 510, a product is selected by a user. According to one method, a user selects a product from product choices 220 (FIGS. 2A-2B) on the exemplary user interface 200 (FIGS. 2A-2B).

At step 520, a visual representation of the selected product is displayed. According to one method, upon a user selecting a product from the product choices 220, a visual representation of the product is displayed in the display window 210 (FIGS. 2A-2B) of the exemplary user interface 200.

At step 530, the user selects a background for application to at least a portion of the surface of the selected product. According to various methods, the background is selected from the plurality of background choices 230 (FIGS. 2A-2B) on the exemplary user interface 200.

At step 540, the user adds or selects one or more items of digital content or foreground items to at least a portion of the surface of the product. According one method, the item of digital content is added to at least a portion of the surface of the product by using the digital content or foreground item selection 240 (FIGS. 2A-2B) on the exemplary user interface 200.

At step 550, the user may edit the item(s) of digital content or foreground item(s) added to the product. According to various methods, the exemplary editing screen 300 (FIG. 3) enables a user to arrange digital content as displayed in edit display window 350 (FIG. 3), while simultaneously seeing a display of the edits with respect to a particular product in the multiple product angle display window 340 (FIG. 3).

At step 560, the user may align the background and/or item(s) of digital content appearing on the product. According to one method, the user may click and drag one or more control points, such as representative control point 410 (FIG. 4) and/or representative control point 420 (FIG. 4) to generate an aesthetically satisfying alignment of a background and/or item(s) of digital content with respect to a particular product.

At step 570, a display, view, or preview of the product with the item(s) of digital content is generated. According to various exemplary methods, the generated display is substantially similar to a view of a physical form of the same product with the same item of digital content. In other words, a visual representation of the product is generated as it is expected to appear with the background and foreground item applied thereto.

While various systems and methods have been described above, it should be understood that they have been presented by way of example only, and not limitation. Thus, the breadth and scope of a preferred embodiment should not be limited by any of the described exemplary embodiments.

What is claimed is:

1. A computer implemented method of previewing a product with user selected ornamentation comprising:
displaying a visual representation of a product selected from a plurality of product choices;
selecting a background from a plurality of background choices for application to at least a portion of a surface of the product;
selecting a foreground item for application to at least a portion of the surface of the product; and
generating a visual representation of the product as it is expected to appear with the background and foreground item applied thereto.

2. The method of claim 1, further comprising editing the background.

3. The method of claim 1, further comprising editing the foreground item.

4. The method of claim 1, further comprising selecting the portion of the surface to which the foreground item is to be applied.

5. The method of claim 4, wherein the step of selecting the portion of the surface to which the foreground item is to be applied further comprises aligning the foreground item with control points.

6. The method of claim 1, further comprising:
displaying a visual representation of a second product from the plurality of product choices; and
generating a visual representation of the second product as it is expected to appear with the background and foreground item applied thereto.

7. The method of claim 1, wherein the product is a mug.

8. The method of claim 1, wherein the product is a T-shirt.

9. The method of claim 1, wherein the product is a poster.

10. The method of claim 1, wherein the product is a plate.

11. The method of claim 1, wherein the foreground item is a photograph.

12. A system for dynamically designing a product with digital content comprising:
a user interface, the user interface configured to allow a user to select:
a product from a plurality of product choices;
a background from a plurality of background choices; and
a foreground item;
a display for displaying the product; and
a processor for generating a representation of the product as it is expected to appear with the background and foreground item applied thereto.

13. The system of claim 12, the user interface further configured to allow the user to edit the foreground item.

14. The system of claim 12, the user interface further configured to allow the user to edit the background.

15. The system of claim 12, the user interface further configured to allow the user to select a portion of a surface to which the foreground item is to be applied.

16. The system of claim 15, the user interface further configured to allow the user to select the surface with control points.

18. A computer readable medium having embodied thereon a program, the program being executable by a processor for performing a method for dynamically designing a product with digital content, the method comprising:
displaying a visual representation of a product selected from a plurality of product choices;
selecting a background from a plurality of background choices for application to at least a portion of a surface of the product;
selecting a foreground item for application to at least a portion of the surface of the product; and
generating a visual representation of the product as it is expected to appear with the background and foreground item applied thereto.

19. The computer readable medium of claim 18, the method further comprising editing the item of digital content.

20. The computer readable medium of claim 18, the method further comprising selecting the portion of the surface to which the foreground item is to be applied.
